(19) United States
(12) Patent Application Publication
(10) Pub. No.: US 2015/0046717 A1
(43) Pub. Date: Feb. 12, 2015

(54) SEMICONDUCTOR APPARATUS

(71) Applicant: Kabushiki Kaisha Toshiba, Tokyo (JP)

(72) Inventors: Masayuki Hagiwara, Kanagawa (JP); Takeshi Obara, Kanagawa (JP)

(73) Assignee: KABUSHIKI KAISHA TOSHIBA, Tokyo (JP)

(21) Appl. No.: 14/193,495

(22) Filed: Feb. 28, 2014

(30) Foreign Application Priority Data
Aug. 12, 2013 (JP) 2013-167603

(51) Int. Cl. G06F 21/57

(52) U.S. Cl. CPC G06F 21/575
USPC 713/187

(57) ABSTRACT

A semiconductor apparatus of an embodiment is provided with: a NAND memory configured to store a startup program; a ROM configured to store firmware activating the startup program; an OTP memory configured to store a hash value of the startup program; and a CPU configured to perform falsification detection of the startup program by comparing the hash value stored in the OTP memory and a hash value calculated from the startup program stored in the NAND memory, to execute the startup program if falsification is not detected, and to stop a startup process if falsification is detected.

### CROSS-REFERENCE TO RELATED APPLICATION

This application claims the benefit of Japanese Application No. 2013-167603 filed in Japan on Aug. 12, 2013, the contents of which are incorporated herein by this reference.

### FIELD

An embodiment described herein relates generally to a semiconductor apparatus which performs falsification detection of a startup program at the time of startup.

### BACKGROUND

Semiconductor apparatuses are used to store startup information about various kinds of electronic devices. For example, a smart TV, a wireless communication apparatus such as a mobile phone, a set top box, or an electronic device system configured by combination thereof has a semiconductor apparatus which includes, for example, a controller and a writable nonvolatile memory storing firmware and a startup program, such as a boot loader, used by the controller at the time of startup.

Especially, a semiconductor apparatus in which an SoC (system on chip), a nonvolatile memory and the like are implemented on a circuit board is used to start up an electronic device. In the SoC (system on chip), components such as a CPU and a ROM are integrated in one chip. As the nonvolatile memory, a rewritable mass memory, for example, a NAND memory (NAND-type flash memory) is used.

In development of an electronic device, firmware, which is a first startup program to be stored in the ROM of an SoC, is determined early in the development. In comparison, the boot loader, which is a second startup program to be stored in the rewritable memory such as a NAND memory, may be changed immediately before shipment because of addition or change of a function of the electronic device or change in specifications due to a factor such as cost. Therefore, it is often the case to decide the firmware having minimal functions required for startup and the like of a main startup program (boot loader) first, store the firmware in the ROM, and, as for additional functions, store the boot loader and an operating system in the nonvolatile memory such as a NAND memory.

There is a possibility that the startup program stored in the rewritable memory is falsified by a third person after shipment. It is feared that, if a malicious code is incorporated into the startup program, all security procedures are bypassed.

For example, if a startup program of a semiconductor apparatus which starts up a smart TV is falsified, there is a possibility that pay broadcast is viewed free of charge.

From a viewpoint of ensuring security, it is preferable to store the startup program in a ROM where there is not a possibility of the startup program being falsified. However, since storage into a ROM is so-called hard coding, it is troublesome to perform update.

Therefore, for example, a configuration is proposed in which, by storing firmware and a startup program in a ROM and storing security information for ensuring security and an additional program in a rewritable nonvolatile memory, it is not necessary to update the ROM even if the additional program is changed.

Demands of clients who purchase SoCs to manufacture electronic device systems are varied. In order to provide an SoC which can realize a demand, it is preferable to respond to the demand with an SoC mass produced in advance. It is also preferable to store the security information in the ROM of the SoC.

However, if SoCs in which the same security information is stored in the ROMs are mass produced, there is a problem that, when a situation happens that the security information is disclosed, all the SoCs in which the same security information is written are influenced. On the other hand, if multiple kinds of SoCs in which different pieces of security information are stored in the ROMs are mass produced in order to restrict influence of disclosure, there is a problem that management/distribution of the SoCs and startup information after manufacture is troublesome.

That is, trade-off between certainty of security and efficiency of mass-production management occurs. Thus, there has been a demand for a semiconductor which maintains sufficient security even if the ROM is not updated and which is capable of storing information required for detecting falsification of a startup program, that is, a semiconductor with excellent mass-productivity for which security is ensured.

### BRIEF DESCRIPTION OF THE DRAWINGS

FIG. 1 is a configuration diagram of an electronic device system including a semiconductor apparatus of an embodiment;

FIG. 2 is a flowchart of a manufacturing process of the semiconductor apparatus of the embodiment;

FIG. 3 is a flowchart of a method for starting up the semiconductor apparatus of the embodiment;

FIG. 4 is a flowchart of a method for starting up a semiconductor apparatus of a modification 1 of the embodiment;

FIG. 5 is a flowchart of a method for starting up a semiconductor apparatus of a modification 2 of the embodiment;

FIG. 6 is a flowchart of a method for starting up a semiconductor apparatus of a modification 3 of the embodiment;

FIG. 7 is a flowchart of a method for starting up a semiconductor apparatus of a modification 4 of the embodiment; and

FIG. 8 is a flowchart of a method for starting up a semiconductor apparatus of a modification 5 of the embodiment.

### DETAILED DESCRIPTION

A semiconductor apparatus of an embodiment is provided with: a writable nonvolatile memory configured to store a startup program; a ROM configured to store firmware activating the startup program; an OTP (one time programmable) memory configured to store security information, which is a hash value of the startup program; and a controller configured to perform falsification detection of the startup program by comparing the hash value stored in the OTP memory and a hash value calculated from the startup program stored in the nonvolatile memory, to execute the startup program if falsification is not detected, and to stop a startup process if falsification is detected. The ROM, the OTP memory and the controller are integrated in one chip.

### <Configuration of Semiconductor Apparatus>

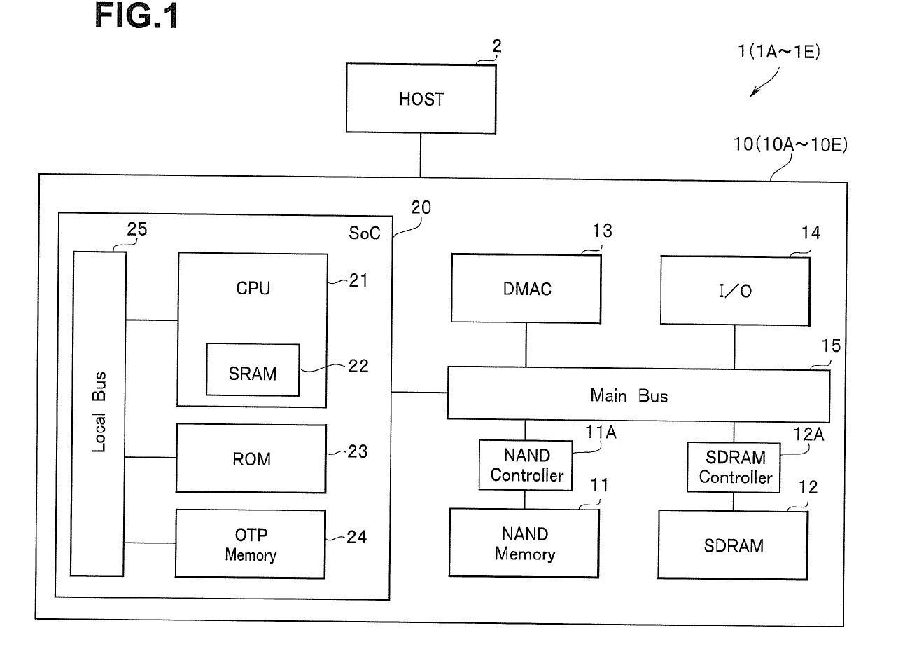

First, a configuration of a semiconductor apparatus 10 of an embodiment of the present invention will be described with the use of FIG. 1. The semiconductor apparatus 10 constitutes an electronic device system 1, which is a smart TV, together with a host 2 having a content transmitting/receiving function and a content display function. Though the semiconductor apparatus 10 is a device for starting up the host 2, the semiconductor apparatus 10 is, for example, included inside the smart TV in appearance and integrated with the host 2.

The semiconductor apparatus 10 has a NAND memory 11, an SDRAM 12, a DMAC (direct memory access controller) 13 and an I/O 14, each of which is connected to an SoC 20 via a main bus 15. The NAND memory is a rewritable nonvolatile memory.

Inside the SoC 20, components such as a CPU 21, a ROM 23 and an OTP (one time programmable) memory 24 connected to one another to transfer data are integrated in one chip.

The CPU 21, which is a controller, has an SRAM 22 in which a program or the like is developed and executed. Note that, in the semiconductor apparatus 10 of the present embodiment, the CPU 21 includes security H/W (hardware) configured to perform hash operation and detect data falsification from an operation result, as described later.

An SRAM (static random access memory) 22 is an operation memory enabling information to be taken in and out at a high speed, that is, enabling high-speed signal processing for calculation and the like because data is stored with the use of a sequential circuit such as a flip-flop circuit.

The ROM 23, which is a nonvolatile read-only memory, is adapted to store particular data by a designed wiring structure and is a so-called mask ROM in which data is etched in hardware when an integrated circuit is manufactured with a photo mask. Note that, as described later, the ROM 23 stores firmware, which is a first startup program for starting up a boot loader which is a second startup program (main startup program).

In comparison, the OTP memory 24 is a nonvolatile read-only memory, and it is impossible to delete or rewrite data once the data is written. For example, in the OTP memory 24, it is possible to perform electrical writing into a NAND memory cell provided with a fuse element only once. Note that, as a method for performing electrical writing into a memory cell only once, high voltage exceeding a maximum rating is applied to a gate insulator of the fuse element in an MOS structure to destroy the insulator so that information “0” is stored in the fuse element before the insulator destruction, and information “1” is stored in the fuse element after the insulator destruction. Alternatively, information may be stored by causing a current to flow through gate wiring to cause a physical phenomenon like electromigration and causing a silicide region forming the wiring or a part of the wiring to be disconnected (to be high-resistant).

Since the SDRAM (synchronous dynamic random access memory) 12 controlled by an SDRAM controller 12A operates in synchronization with the main bus 15, the SDRAM can have more complicated operation patterns than an asynchronous DRAM and can operate at a higher speed. The boot loader and the operating system are developed in the SDRAM 12 when being executed.

The DMAC 13 enables, for example, memory-to-memory data block transfer. Data transfer by an independent entity drastically reduces a load on a processor. The DMAC 13 enables data transfer between a memory inside the SoC 20 and the SDRAM 12.

The I/O 14 has a function of interface between the semiconductor apparatus 10 and the host 2. If the semiconductor apparatus 10 is provided with a dedicated display section (not shown), the display section is also connected via the I/O 14.

### <Manufacture of Semiconductor Apparatus>

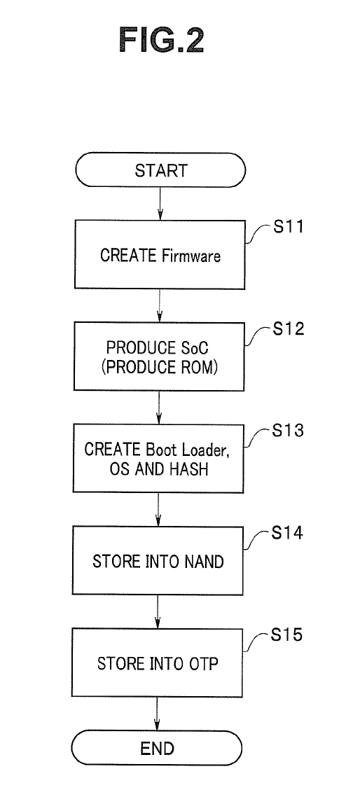

Next, a process for manufacturing the semiconductor apparatus 10 will be simply described along a flowchart in FIG. 2.

### <Step S11>

First, the firmware, which is software for performing minimum startup control of hardware, is created.

### <Step S12>

Circuit design is performed on the basis of the firmware, and the ROM 23 is produced on the basis of the circuit design. Though the ROM 23 is a part of the SoC 20, the SoC 20 is produced simultaneously when the ROM 23 is produced because the CPU 21 and the like are produced with same design even if hardware specifications are a little different.

### <Step S13>

The OS (operating system) which is basic software of the electronic device system 1, the boot loader which is a startup program (startup data) operating immediately after startup and starting up the OS and the like, and software such as a main program are created.

Then, a hash value of the boot loader is calculated. The hash value is a pseudorandom number with a fixed length generated from data of the startup program and the like. Since the hash value includes an irreversible one-way function, it is not possible to reproduce an original sentence from the hash value, and it is extremely difficult to create different data having the same hash value.

As a function for calculating the hash value, SHA-1 (secure hash algorithm 1), MD5 (message digest 5) or the like is used.

The SHA-1 was adopted by the U.S. National Institute of Standards and Technology in 1995 as a standard hash function of the American government. The SHA-1 is applied to IPSec and the like for securely performing communication on the Internet. The MD5 is standardized by IETF as RFC 1321.

For example, by executing the hash function for all or a part of the boot loader to calculate a hash value thereof.

### <Step S14>

The SoC 20, the NAND memory 11 and the like are implemented on a circuit board to produce the hardware of the semiconductor apparatus 10. Then, the software such as the boot loader, the OS and the main program is stored in the NAND memory 11.

### <Step S15>

The calculated hash value of the boot loader is stored in the OTP memory 24 of the SoC 20.

Note that step 14 and step 15 may be executed in opposite order. Furthermore, a memory in which data is stored may be implemented on the circuit board.

By the semiconductor apparatus 10 in which the software is stored being connected to the host 2, the electronic device system 1 is completed.

### <Startup Method>

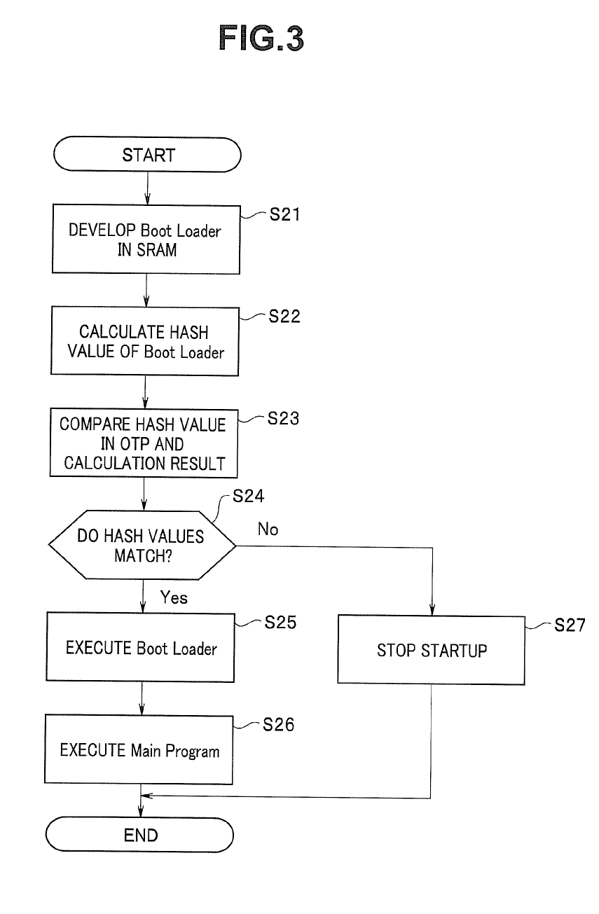

Next, a method for starting up the electronic device system 1 by the semiconductor apparatus 10 will be described along a flowchart in FIG. 3.

### <Step S21>

When power is turned on, the CPU 21 starts execution of the firmware stored in the ROM 23, detects configuration of the components existing on the bus and initializes a NAND controller 11A. Hereinafter, “control the CPU 21 performs by software such as the firmware” may be expressed as “control the firmware or the like performs”, and “copying” software to the operation memory will be referred to as “developing” the software.

The firmware causes the data stored in the NAND memory 11 to be in a readable state, initializes the SDRAM controller 12A and causes the SDRAM 12 to be in a readable state. Then, the CPU 21 reads the boot loader from the NAND memory 11 and develops the boot loader in the SRAM 22.

### <Step S22>

The firmware calculates a hash value of the boot loader developed in the SRAM 22 (hash operation). Note that the CPU 21 has a hash operation section as H/W.

### <Step S23>

The firmware compares the calculated hash value and the hash value stored in the OTP memory 24. A comparison result, that is, a falsification detection result is stored, for example, in the SRAM 22.

### <Steps S24 and S25>

If the hash values match (S24: Yes), that is, if falsification is not detected, the firmware shifts control to the boot loader developed in the SRAM 22 and starts execution of the boot loader (main startup program).

### <Step S26>

The boot loader develops the operating system in the SDRAM 12 and starts up the main program and the like.

### <Steps S24 and S27>

If the hash values do not match (S24: No), that is, if falsification of the boot loader, which is a startup program, is detected, the firmware displays, for example, a message of “Startup stopped” on the display section connected to the I/O 14 and stops the startup process. That is, the CPU 21 does not execute the startup program. As described above, in the semiconductor apparatus 10, a hash value, which is security information, is stored in a memory enabling writing only once (the OTP memory 24). Therefore, in the semiconductor apparatus 10, it is possible to write security information in accordance with a client's demand after production of the ROM 23 (S12 in FIG. 2), that is, after manufacture of the SoC 20. Therefore, it is possible to, while maintaining security similar to security at the time of storing the security information into the ROM 23, set security information required for verification of falsification or a falsification verification method after production of the ROM.

That is, according to the present embodiment, it is possible to provide a semiconductor apparatus with excellent mass-productivity for which security is ensured.

Note that, though the electronic device system 1 is a smart TV for which it is important for protection of content that falsification by a third person can be prevented at the time of receiving the content and displaying the content on a monitor, the semiconductor apparatus is applicable to various kinds of electronic device systems intended to prevent execution of a falsified startup program.

The CPU 21, which is a controller performing startup control, may be a general-purpose processor such as an ARM processor or may be a dedicated processor such as other microcontrollers and a DSP. Instead of the security H/W, software which causes the function of the security H/W to be performed as processing by the controller may be incorporated in the firmware.

In the SoC 20 of the semiconductor apparatus 10, the controller which executes the firmware and the boot loader/operating system is the single CPU 21. However, such a configuration is also possible that a controller performing verification and a processor executing the operating system separately exist, for example, a configuration in which boot processing is performed only by a simple microcontroller, and a higher-speed processor processes the operating system.

In the semiconductor apparatus 10, the nonvolatile memory storing the boot loader, the operating system and the like is the single NAND memory 11. However, different nonvolatile memories may store the boot loader, the operating system and the like, respectively. For example, it is possible to, according to program sizes, store the boot loader with a small size in an EEPROM, and the operating system with a large size in the NAND memory 11. An SDRAM may be substituted for the SRAM. In this case, firmware is used which is programmed to initialize the SDRAM at a time point before using the SDRAM. Furthermore, though the DMAC is used for developing a program or the like into the operation memory in the semiconductor apparatus, the development may be performed by a transfer function of the controller itself.

### <Modifications 1 to 5>

Next, semiconductor apparatuses 10A to 10E of modifications of the embodiment will be described. Since the semiconductor apparatus 10A to 10E of the modifications, that is, electronic device systems 1A to 1E have components having functions similar to those of the components of the semiconductor apparatus 10 and the electronic device system 1, description of the components will be omitted.

In the semiconductor apparatuses 10A to 10E, for example, the startup program stored in the NAND memory 11 includes information for verification for detecting falsification of the startup program. The OTP memory 24 stores security information for verifying the information for verification. When the semiconductor apparatus is started up, the CPU 21, which is a controller, reads the security information in the OTP memory 24 and the information for verification in the NAND memory 11, and performs verification of falsification of the startup program using the security information and the information for verification.

### <Modification 1>

In the semiconductor apparatus 10A of the modification 1, falsification detection is performed on the basis of a message authentication code (MAC) as the information for verification. Same common key information is used for generation and verification of the MAC.

In the semiconductor apparatus 10A, the common key information is stored in the OTP memory 24. On the other hand, the MAC is generated from the boot loader and the common key information, and the boot loader which includes the MAC, in other words, the MAC and the boot loader are stored in the NAND memory 11.

In the case of updating the boot loader to add a function to the developed boot loader, a MAC is newly calculated from the updated boot loader and the common key information. Then, the updated boot loader and the updated MAC are stored in the NAND memory 11. As for a method for storing the updated data into the NAND memory 11, the electronic device system is retrieved, and writing into the NAND memory 11 is performed with a writing apparatus or the NAND memory 11 is exchanged. Alternatively, if the electronic device has a function of data communication via a network, such as wireless communication, writing may be performed by the operating system.

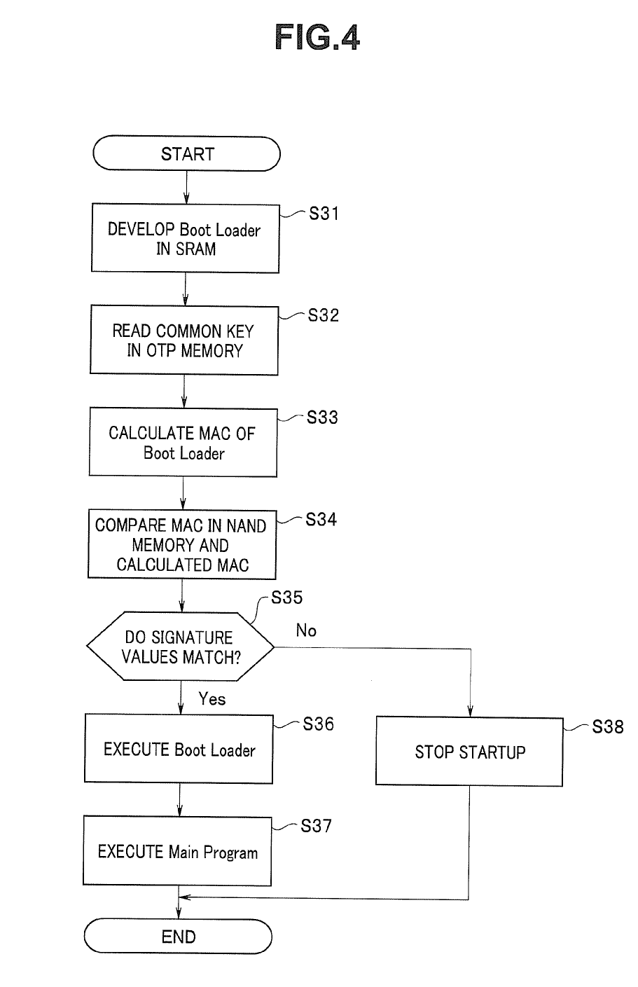

Next, a method for starting up the electronic device system 1 by the semiconductor apparatus 10A will be described along a flowchart in FIG. 4.

### <Step S31>

When the semiconductor apparatus 10A is powered on and started up, the CPU 21 reads the boot loader from the NAND memory 11 by the firmware stored in the ROM 23 and develops the boot loader in the SRAM 22.

### <Step S32>

The CPU 21 reads the common key information stored in the OTP memory 24 by the firmware.

### <Step S33>

The CPU 21 calculates a MAC of the boot loader using the common key information read from the OTP memory 24.

### <Step S34>

The CPU 21 compares the MAC stored in the NAND memory 11 and the calculated MAC.

### <Steps S35 to S37>

If the MACs match (S35: Yes), that is, if falsification is not detected, the CPU 21 executes the boot loader (S36) and starts up the OS and the main program (S37).

### <Steps S35 and S38>

If the MACs do not match (S35: No), that is, if falsification is detected, the CPU 21 does not hand over control from the firmware to the boot loader and stops the startup process.

In the case of providing a verification function based on MAC, different common key information is assigned to each client. Therefore, the semiconductor apparatus 10A has the advantages of the semiconductor apparatus 10 and the like. Furthermore, even if a key for a client having common key information is illegally acquired by a third person, SoCs in which different common key information is written are not influenced, and, therefore, the semiconductor apparatus 10A can restrict the range of influence in the case of the key being disclosed.

As described above, in the semiconductor apparatus 10A, the information for verification is a signature value of the boot loader using a secret key of a public-key cryptosystem; the OTP memory 24 stores a public key; and the CPU 21 uses the public-key cryptosystem to detect falsification of the boot loader.

### <Modification 2>

The semiconductor apparatus 10B of the modification 2 performs falsification detection based on the public-key cryptosystem. That is, a signature value of the startup program and a public key are held as the information for verification; the public key is held as the security information; and the public-key cryptosystem is used to detect falsification.

A developer who designs the electronic device system 1 using the SoC 20 may entrust work of storing data into the OTP memory 24 to an external developer. At this time, there may be a case where the developer wants to perform design without providing key information required for generating the security information to be paired with the startup program, to the external developer. The developer who designs the semiconductor apparatus 10B of the electronic device system 1 generates a secret key and a public key of the public-key cryptosystem.

The secret key is strictly managed by the developer who designs the electronic device system 1. The public key is provided to the external developer. The external developer writes public key information into the OTP memory 24. After creating a boot loader, the developer puts a signature on the boot loader using the secret key and generates signature information (a signature value). Then, the signature value and the boot loader are stored in the NAND memory 11.

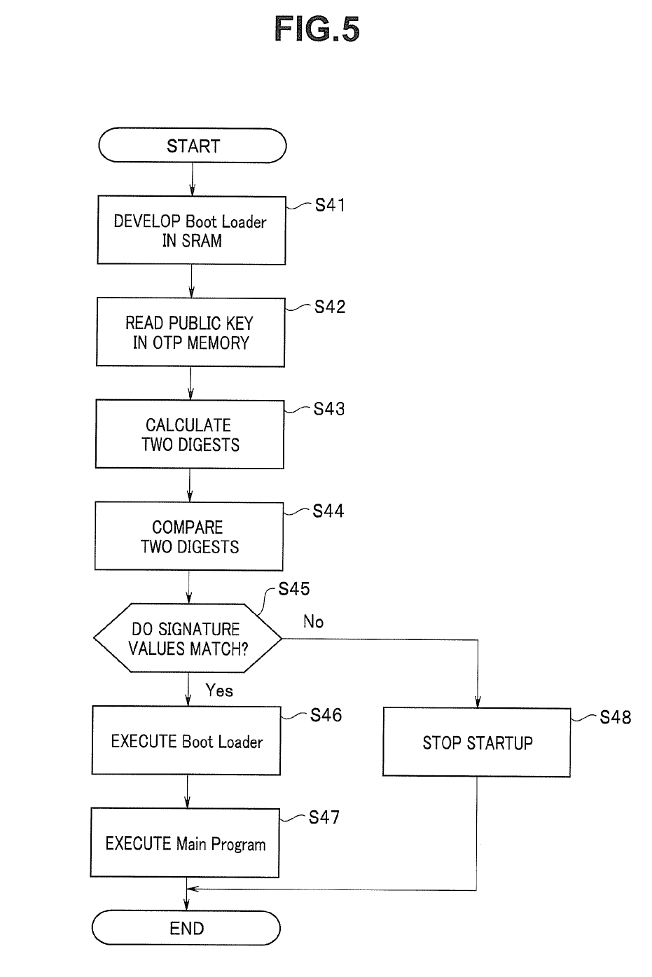

Next, a method for starting up the electronic device system 1 by the semiconductor apparatus 10B will be described along a flowchart in FIG. 5.

### <Step S41>

When the semiconductor apparatus 10B is powered on and started up, the CPU 21 reads the boot loader from the NAND memory 11 by the firmware stored in the ROM 23 and develops the boot loader in the SRAM 22.

### <Step S42>

The CPU 21 reads the public key stored in the OTP memory 24 by the firmware.

### <Step S43>

The CPU 21 reads the boot loader and the signature value stored in the NAND memory 11. Then, the CPU 21 calculates a digest from the public key and the signature value and further calculates a digest from the boot loader.

### <Step S44>

The CPU 21 compares the two respective calculated digests.

### <Steps S45 to S47>

If the digests match (S45: Yes), the CPU 21 executes the boot loader (S46) and starts up the OS and the main program (S47).

### <Steps S45 to S48>

If the digests do not match (S45: No), that is, if falsification is detected, the firmware does not hand over control to the boot loader and stops startup.

As described above, in the semiconductor apparatus 10B, the information for verification is a signature value of the boot loader using a secret key of the public-key cryptosystem; the OTP memory 24 stores a public key; and the CPU 21 uses the public-key cryptosystem to detect falsification of the boot loader.

The semiconductor apparatus 10B has the advantages of the semiconductor apparatus 10 and the like. Furthermore, since the work of storing data into the OTP memory 24 can be entrusted to an external developer, productivity is high.

### <Modification 3>

In the semiconductor apparatus 10C of the modification 3, a MAC is used to detect falsification of the information for verification, and the public-key cryptosystem is used to detect falsification of the startup program. The semiconductor apparatus 10C has a signature value of a program, a public key and a MAC of the public key as the information for verification, and has a secret key of the MAC as the security information. The semiconductor apparatus 10C uses the MAC to detect falsification of the information for verification and uses the public-key cryptosystem to detect falsification of the program.

That is, in a falsification detection method based on the public-key cryptosystem, the semiconductor apparatus 10C is compatible with update of the boot loader shown in the falsification detection method based on the MAC. Signature information is generated by the secret key each time the boot loader is updated.

Note that, instead of the information for verification stored in the OTP memory 24, a hash value of the information for verification may be used.

A data size of a key used in the public-key cryptosystem may be larger than a data size of a hash value. Even if the storage capacity of the OTP memory 24 is not sufficient, the semiconductor apparatus 10C can store a hash value of a public key instead of storing the public key.

In this case, the external developer is provided not with the public key but with the hash value of the public key. Then, the hash value of the public key is stored into the OTP memory 24 by the external developer. On the other hand, after creation of the boot loader, the boot loader is signed with a secret key, and signature information is generated. Then, the signature information, the boot loader and the public key are stored into the NAND memory 11.

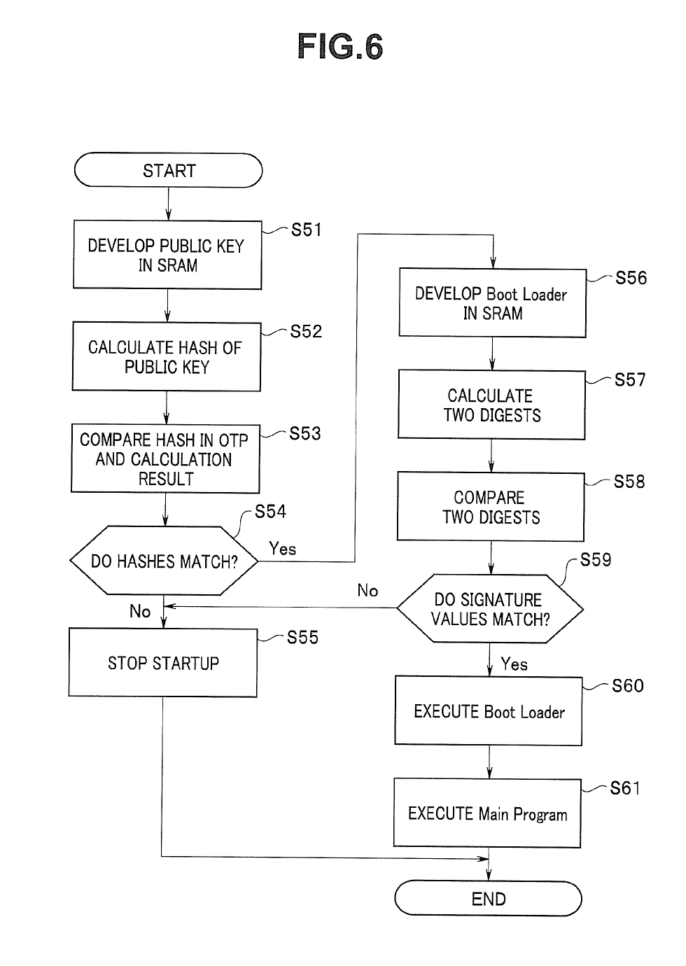

Next, a method for starting up the electronic device system 1 by the semiconductor apparatus 10C will be described along a flowchart in FIG. 6.

### <Step S51>

When the semiconductor apparatus 10C is powered on and started up, the CPU 21 reads the public key from the NAND memory 11 by the firmware stored in the ROM 23 and develops the public key in the SRAM 22.

### <Step S52>

The CPU 21 calculates a hash value of the public key by the firmware.

### <Step S53>

The CPU 21 compares the calculated hash value and the hash value read from the OTP memory 24.

### <Steps S54 and S55>

If the signature values do not match (S54: No), that is, if falsification is detected, the CPU 21 does not hand over control from the firmware to the boot loader and stops the startup process.

### <Steps S54 and S56>

If the signature values match (S54: Yes), the CPU 21 further verifies falsification of the boot loader and the signature using the public key.

That is, the CPU 21 reads the boot loader from the NAND memory 11 and develops the boot loader in the SRAM 22 at this step.

### <Step S57>

The CPU 21 calculates a digest of the boot loader developed in the SRAM 22 by the firmware. Furthermore, the CPU 21 calculates a digest from the public key and the signature value by the firmware.

### <Step S58>

The CPU 21 compares the two respective calculated digests.

### <Steps S59 to S61>

If the digests match (S59: Yes), the CPU 21 shifts control from the firmware to the boot loader developed in the SRAM 22 and starts execution.

On the other hand, if the signature values do not match (S59: No), the CPU 21 stops startup. That is, the CPU 21 does not execute the startup program.

As described above, in the semiconductor apparatus 10C, the information for verification is a signature value of the boot loader using a secret key of the public-key cryptosystem; the OTP memory stores a hash value of a public key; the CPU uses hash operation to detect falsification of the information for verification and farther uses the public-key cryptosystem to detect falsification of the boot loader.

The semiconductor apparatus 10C has the advantages of the semiconductor apparatus 10 and the like. Furthermore, the semiconductor apparatus 10C can maintain higher security.

Note that, though the hash value of the public key is stored in the OTP memory 24 in the modification 3, the MAC may be used for verification of the public key.

### <Modification 4>

The semiconductor apparatus 10D of the modification 4 includes the firmware which is provided with all of the multiple verification methods (falsification detection methods) already described. The security information includes flag information (a control flag), and the falsification detection methods are switched according to the flag information. That is, in the semiconductor apparatus 10D, the security information includes the flag information; the firmware has the multiple falsification verification methods; and the falsification verification methods are switched according to the flag information.

In the semiconductor apparatus 10D, flag information required at the time of selecting a falsification detection method is stored in the ROM 23 or the OTP memory 24. Then, the CPU 21 reads a control flag from the OTP memory 24, judges a verification method and performs falsification detection according to a judgment result.

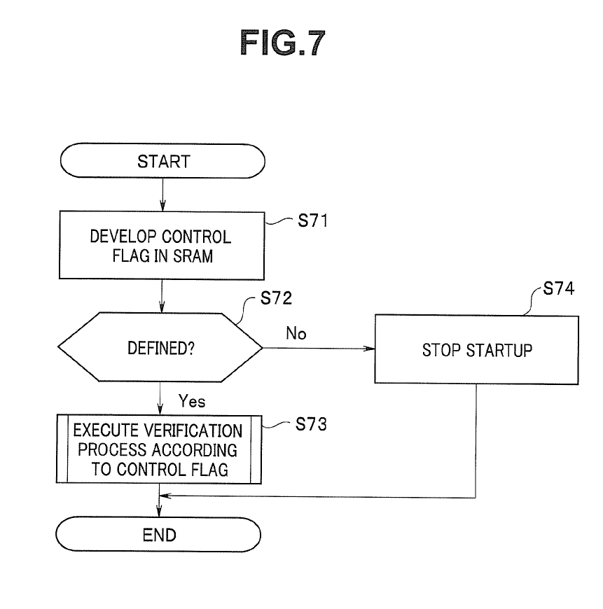

Next, a method for starting up the electronic device system 1 by the semiconductor apparatus 10D will be described along a flowchart in FIG. 7.

### <Step S71>

When the semiconductor apparatus 10D is started up, the CPU 21 reads the flag information and develops the flag information in the SRAM 22.

### <Steps S72 and S73>

If the flag information is defined (S72: Yes), the CPU 21 judges a verification method and executes a falsification detection process by the verification method according to the flag information, for example, the process from step S22 shown in FIG. 3 or the process from step S32 shown in FIG. 4.

### <Step S74>

If the flag information is not defined (S72: No), the CPU 21 stops startup. That is, if an incorrect value other than the defined control flag is written because of breakage of the OTP memory 24 or a wrong operation or the like, the CPU 21 terminates the boot process.

The semiconductor apparatus 10D has the advantages of the semiconductor apparatus 10 and the like and can perform detection of falsification more efficiently.

### <Modification 5>

The semiconductor apparatus 10E of the modification 5 is similar to the semiconductor apparatus 10D. However, the semiconductor apparatus 10E has verification information corresponding to each of the multiple verification methods and sequentially executes the multiple falsification detection processes one by one according to the stored verification information. The flag information has multiple fields corresponding to the multiple verification methods executed at the time of startup.

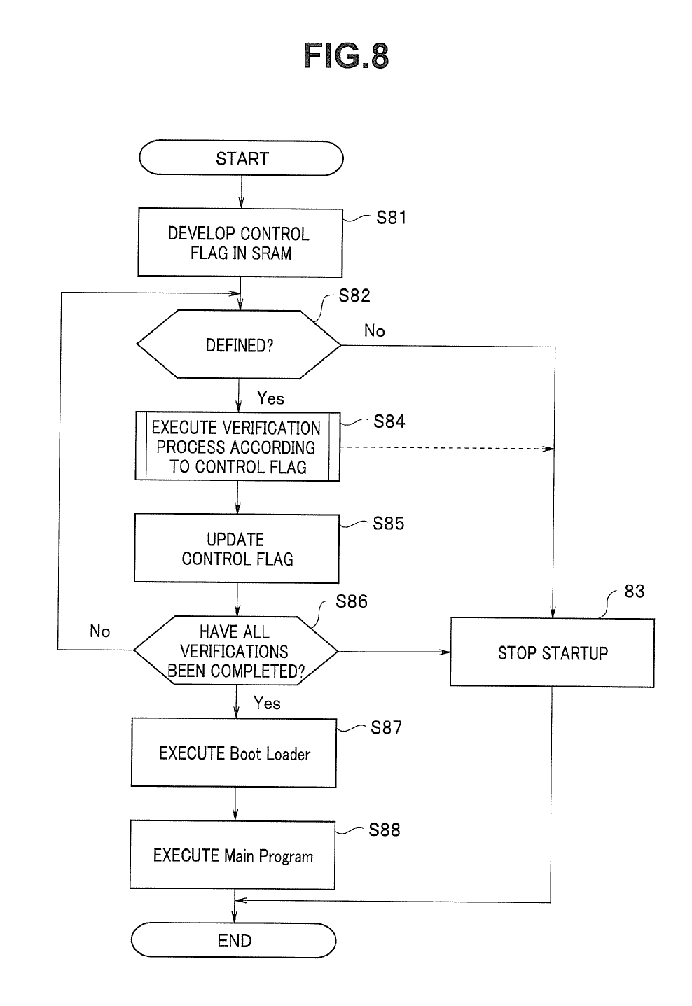

Next, a method for starting up the electronic device system 1 by the semiconductor apparatus 10E will be described along a flowchart in FIG. 8.

### <Step S81>

When the semiconductor apparatus 10E is started up, the CPU 21 reads the flag information by the firmware and develops the flag information in the SRAM 22. The flag information includes execution order of the multiple verification methods.

### <Steps S82 and S83>

If the flag information is not defined (S83: No), the CPU 21 stops startup. That is, the CPU 21 terminates the boot process.

### <Step S84>

The CPU 21 sequentially executes the multiple verification processes one by one in the preset order of the fields included in the flag information.

### <Step S85>

The CPU 21 updates the flag information each time the CPU 21 executes one verification process.

### <Step S86>

The CPU 21 repeats the process from step S82 as long as all the verification processes specified by the flag information have not been completed (S86: No).

### <Step S87>

When all the verification processes are completed (S86: Yes), control by the firmware is switched to control by the boot loader if falsification is not detected in any of the verification processes. Then, the OS and the main program are executed (S87 and S88). In other words, the firmware shifts control to the boot loader after confirming that all the verification processes written in the flag information have been performed. If the flag information stored in the OTP memory 24 is incorrect or if falsification is detected at any time point, the firmware does not hand over control to the boot loader.

That is, in the semiconductor apparatus 10E, the flag information for selecting a falsification detection method is stored in the ROM 23 or the OTP memory 24, and the CPU 21 sequentially executes the multiple falsification detection methods one by one according to the flag information.

The semiconductor apparatus 10E has the advantages of the semiconductor apparatus 10 and the like. Furthermore, since multiple verification methods are sequentially implemented one by one, certainty of falsification detection is high.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A semiconductor apparatus comprising:
a writable nonvolatile memory configured to store a startup program;
a ROM configured to store firmware activating the startup program;
a one time programmable (OTP) memory configured to store a hash value of the startup program; and
a controller integrated in one chip together with the ROM and the OTP memory and configured to perform falsification detection of the startup program by comparing the hash value stored in the OTP memory and a hash value calculated from the startup program stored in the nonvolatile memory, to execute the startup program if falsification is not detected, and to stop a startup process if falsification is detected.

2. A semiconductor apparatus comprising:
a writable nonvolatile memory configured to store a startup program;
a ROM configured to store firmware activating the startup program;
a one time programmable (OTP) memory configured to store security information of the startup program; and
a controller configured to perform falsification detection of the startup program using the security information stored in the OTP memory and the startup program stored in the nonvolatile memory, to execute the startup program if falsification is not detected, and to stop a startup process if falsification is detected.

3. The semiconductor apparatus according to claim 2, wherein the ROM, the OTP memory and the controller are integrated in one chip.

4. The semiconductor apparatus according to claim 3, wherein the security information includes a hash value of the startup program, and the controller uses hash operation to perform the falsification detection.

5. The semiconductor apparatus according to claim 4, wherein the security information is a hash value of a part of the startup program.

6. The semiconductor apparatus according to claim 2, wherein the startup program includes information for verification; the OTP memory stores the security information for verifying the information for verification; and the controller uses the security information and the information for verification to perform the falsification detection.

7. The semiconductor apparatus according to claim 6, wherein the information for verification is a MAC (message authentication code) generated from the startup program and common key information; the OTP memory stores the common key information as the security information; and the controller uses the MAC to perform the falsification detection.

8. The semiconductor apparatus according to claim 6, wherein the information for verification is a signature value of the startup program using a secret key of a public-key cryptosystem; the OTP memory stores a public key; and the controller uses the public-key cryptosystem to perform the falsification detection of the startup program.

9. The semiconductor apparatus according to claim 6, wherein the information for verification is a signature value of the startup program using a secret key of a public-key cryptosystem; the OTP memory stores a hash value of a public key; and the controller uses hash operation to perform falsification detection of the information for verification and, furthermore, uses a public-key cryptosystem to perform the falsification detection of the startup program.

10. The semiconductor apparatus according to claim 6, wherein the controller performs the falsification detection of the startup program using at least one falsification detection method selected from:
a method 1 in which the startup program includes the information for verification; the OTP memory stores the security information for verifying the information for verification; and the controller uses the security information and the information for verification to perform the falsification detection;
a method 2 in which the information for verification is a MAC (message authentication code) generated from the startup program and common key information; the OTP memory stores the common key information as the security information; and the controller uses the MAC to perform the falsification detection;
a method 3 in which the information for verification is a signature value of the startup program using a secret key of a public-key cryptosystem; the OTP memory stores a public key; and the controller uses the public-key cryptosystem to perform the falsification detection of the startup program; and
a method 4 in which the information for verification is a signature value of the startup program using a secret key of a public-key cryptosystem; the OTP memory stores a hash value of a public key; and the controller uses hash operation to perform falsification detection of the information for verification and, furthermore, uses a public-key cryptosystem to perform the falsification detection of the startup program.

11. The semiconductor apparatus according to claim 10, wherein
flag information for selecting a falsification detection method to be implemented by the controller is stored in the ROM or the OTP memory; and
the controller sequentially implements multiple falsification detection methods one by one according to the flag information.
